(19) United States
(12) Patent Application Publication
(10) Pub. No.: US 2023/0267550 A1
(43) Pub. Date: Aug. 24, 2023

(54) INFORMATION PROCESSING DEVICE, INFORMATION PROCESSING SYSTEM, AND INFORMATION PROCESSING METHOD, AND PROGRAM

(71) Applicant: Sony Group Corporation, Tokyo (JP)

(72) Inventor: Ryosuke FURUKAWA, Tokyo (JP)

(73) Assignee: Sony Group Corporation, Tokyo (JP)

(21) Appl. No.: 18/015,258

(22) PCT Filed: Jul. 21, 2021
(86) PCT No.: PCT/JP2021/027257

§ 371 Date: Jan. 9, 2023

(30) Foreign Application Priority Data
Aug. 7, 2020 (JP) 2020-134668

(51) Int. Cl. G06Q 40/08

(52) U.S. Cl. CPC G06Q 40/08; G16Y 10/50

(57) ABSTRACT

There is provided an information processing device, an information processing method, an information processing system, and a program which enable presentation a result of behavior modification of the entire group. Information regarding a driving habit of a user of a pay how you drive (PHYD) automobile insurance is acquired as travel risk information. A relative accident occurrence rate is calculated from travel risk information of a user of a pay how you drive (PHYD) automobile insurance and travel risk information of a user of a general automobile insurance. A claim cost of the PHYD automobile insurance is calculated by multiplying a claim cost of the general automobile insurance by a proportion of a total number of policyholders of the PHYD automobile insurance with respect to a total number of policyholders of the general automobile insurance. A reduced claim cost of the PHYD automobile insurance is calculated and presented by multiplying the claim cost of the PHYD automobile insurance by the relative accident occurrence rate. The present disclosure can be applied to a pay how you drive (PHYD) automobile insurance management system.

### TECHNICAL FIELD

The present disclosure relates to an information processing device, an information processing method, an information processing system, and a program, and more particularly, to an information processing device, an information processing method, an information processing system, and a program which enable presentation a result of behavior modification of the entire group.

### BACKGROUND ART

With respect to insurance premiums so far, a uniform insurance premium has been set for insurance subscribers (users).

However, in recent years, an insurance that sets an insurance premium on the basis of an individual risk factor of an insurance subscriber (user) has appeared.

Therefore, there is proposed a technology for calculating an insurance premium on the basis of an individual risk factor of an insurance subscriber (user) (see Patent Document 1).

According to the technology of Patent Document 1, an individual insurance premium can be set on the basis of the individual risk factor of the insurance subscriber, and thus, it is possible to give an incentive to generate cashback of the insurance premium when there is behavior modification to lower a risk regarding the behavior related to the risk factor.

### CITATION LIST

### Patent Document

Patent Document 1: Japanese Patent Application Laid-Open No. 2002-373259

### SUMMARY OF THE INVENTION

### Problems to be Solved by the Invention

However, in the technology of Patent Document 1, it is difficult to present a degree of risk reduction and a cashback amount according to behavior modification of the entire insurance subscriber although it is possible to present individual cashback by setting the individual insurance premium on the basis of the individual risk factor of the insurance subscriber.

The present disclosure has been made in view of such a situation, and enables presentation of a result of behavior modification of the entire group.

### Solutions to Problems

An information processing device, an information processing system, and a program according to one aspect of the present disclosure are an information processing device, an information processing system, and a program including: a risk acquisition unit that acquires information indicating a degree of a risk occurring depending on an action of a user for a service as risk information, the information being related to the service provided in accordance with the action of the user obtained from a sensor; and a reduced cost calculation unit that calculates a cost to be reduced from a cost related to the provision of the service as a reduced cost on the basis of the risk information.

An information processing method according to one aspect of the present disclosure is an information processing method including: a step of acquiring information indicating a degree of a risk occurring depending on an action of a user for a service as risk information, the information being related to the service provided in accordance with the action of the user obtained from a sensor; and a step of calculating a cost to be reduced from a cost related to the provision of the service as a reduced cost on the basis of the risk information.

In one aspect of the present disclosure, information indicating a degree of a risk occurring depending on an action of a user for a service is acquired as risk information, the information being related to the service provided in accordance with the action of the user obtained from a sensor, and a cost to be reduced from a cost related to the provision of the service is calculated as a reduced cost on the basis of the risk information.

### BRIEF DESCRIPTION OF DRAWINGS

FIG. 1 is a diagram for describing an overview of a PHYD automobile insurance.

FIG. 2 is a diagram for describing an overview of the present disclosure.

FIG. 3 is a block diagram illustrating a configuration example of a PHYD automobile insurance system of the present disclosure.

FIG. 4 is a block diagram illustrating a configuration example of a smartphone.

FIG. 5 is a block diagram illustrating a configuration example of a PHYD automobile insurance management server.

FIG. 6 is a block diagram illustrating a configuration example of a general automobile insurance management server.

FIG. 7 is a functional block diagram for describing functions implemented by the PHYD automobile insurance system of FIG. 3.

FIG. 8 is a diagram for describing an example of an image that presents a reduced claim cost.

FIG. 9 is a diagram for describing an example of the image that presents the reduced claim cost.

FIG. 10 is a diagram for describing an example of the image that presents the reduced claim cost.

FIG. 11 is a diagram for describing an example of the image that presents the reduced claim cost.

FIG. 12 is a diagram for describing an example of the image that presents the reduced claim cost.

FIG. 13 is a flowchart illustrating reduced claim cost presentation processing by a vehicle in FIG. 7.

FIG. 14 is a flowchart illustrating reduced claim cost presentation processing by the PHYD automobile insurance management server in FIG. 7.

FIG. 15 is a flowchart illustrating reduced claim cost presentation processing by the general automobile insurance management server in FIG. 7.

FIG. 16 is a diagram illustrating a configuration example of a general-purpose computer.

### MODE FOR CARRYING OUT THE INVENTION

Hereinafter, preferred embodiments of the present disclosure will be described in detail with reference to the accompanying drawings. Note that constituent elements having substantially the same functional configuration in the present specification and the drawings will be denoted by the same reference sign, and the redundant description thereof will be omitted.

Hereinafter, modes for carrying out the present technology will be described. A description will be given in the following order.
1. Overview of Present Disclosure
2. Preferred Embodiment
3. Example Executed by Software

### 1. Overview of Present Disclosure

### Overview of PHYD Automobile Insurance Service

The present disclosure enables presentation of a result of behavior modification of the entire group of insurance subscribers to the insurance subscribers.

Since a system that achieves a pay how you drive (PHYD) automobile insurance is used as a configuration example of a preferred embodiment of the present disclosure, first, an overview of a PHYD automobile insurance service will be described.

The PHYD automobile insurance service is an automobile insurance in which an insurance premium is set in conjunction with a driving behavior, and a method of setting an insurance premium is different from a conventional automobile insurance (pay as you drive (PAYD) automobile insurance) in which an insurance premium is set in conjunction with a mileage.

That is, an insurance premium is only set on the basis of a past mileage of an insurance subscriber in the conventional automobile insurance (pay as you drive (PAYD) automobile insurance) service, whereas behavior modification of an insurance subscriber is recognized on the basis of an action related to driving of the insurance subscriber, and an insurance premium is set (cashback of the insurance premium is set) according to a degree of driving safety based on the behavior modification in the PHYD automobile insurance service.

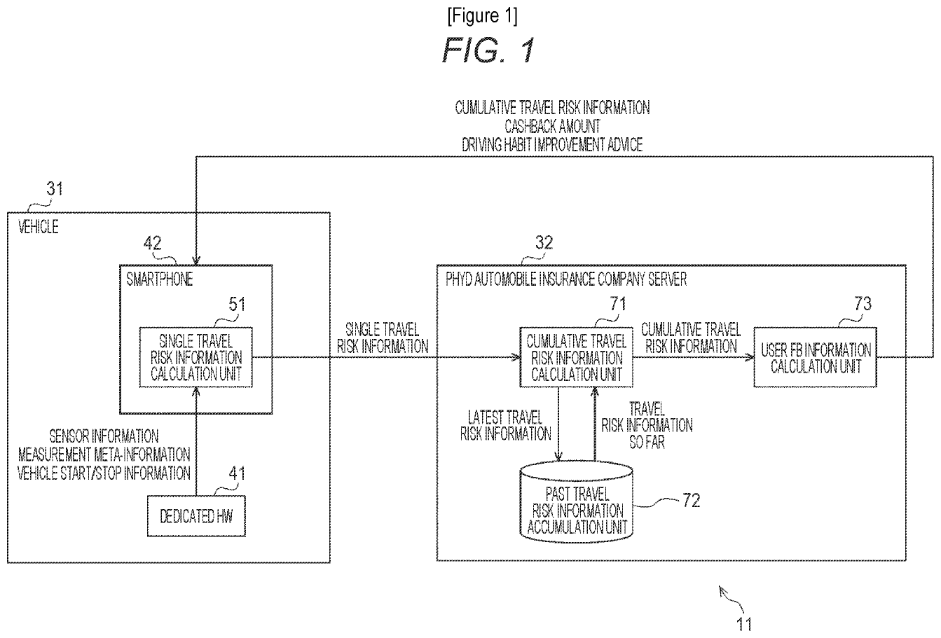

More specifically, a PHYD automobile insurance system has, for example, a configuration as illustrated in FIG. 1.

That is, a PHYD automobile insurance system 11 in FIG. 1 includes a vehicle 31 and a PHYD automobile insurance company server 32.

The vehicle 31 is a vehicle driven by an insurance subscriber who is a driver (user), and includes a dedicated HW (Hardwear) 41 and a smartphone 42.

The dedicated HW 41 and the smartphone 42 are configured to be capable of communicating with each other by near field communication such as Bluetooth (registered trademark).

The dedicated HW 41 is, for example, distributed from an insurance company that manages and operates the PHYD automobile insurance service to the insurance subscriber and mounted on the vehicle 31, and includes various sensors, such as an acceleration sensor and an angular velocity sensor, configured to recognize a driving action of the vehicle 31 by the driver who is the insurance subscriber.

The dedicated HW 41 detects an action of the vehicle 31, that is, information such as acceleration and angular velocity related to the action of the vehicle 31 when driven by the driver on the basis of detection results of the various sensors, and transmits the information to the smartphone 42 as a detection result including sensor information and measurement meta-information.

The dedicated HW 41 detects, for example, the presence or absence of vibration, or the like to detect the start and stop of an engine, and transmits the detection result to the smartphone 42.

The smartphone 42 is a portable terminal carried by the insurance subscriber who is the driver, calculates various scores indicating the driving behavior on the basis of information regarding the start and stop of the engine and the detection result indicating an action of the driver including the sensor information and the measurement meta-information transmitted from the dedicated HW 41, and transmits a calculation result as single travel risk information to the PHYD automobile insurance company server 32.

Furthermore, the smartphone 42 receives and presents cumulative travel risk information, a cashback amount, and driving habit improvement advice transmitted from the PHYD automobile insurance company server 32 according to the single travel risk information.

More specifically, a single travel risk information calculation unit 51 calculates a score indicating a habit of one-time driving of the insurance subscriber, who is the driver of the vehicle 31, on the basis of the detection result indicating the action of the driver including the sensor information and the measurement meta-information transmitted from the dedicated HW 41, and outputs the calculated score as the single travel risk information.

The PHYD automobile insurance company server 32 includes a cumulative travel risk information calculation unit 71, a past travel risk information accumulation unit 72, and a user feedback (FB) information generation unit 73.

When acquiring the single travel risk information transmitted from the smartphone 42 possessed by the insurance subscriber who drives the vehicle 31, the cumulative travel risk information calculation unit 71 cumulatively accumulates pieces of the single travel risk information in the past travel risk information accumulation unit 72 to form past travel risk information.

The cumulative travel risk information calculation unit 71 adds the past travel risk information cumulatively accumulated in the past travel risk information accumulation unit 72 and the acquired single travel risk information to calculate cumulative travel risk information at the current time and supplies the cumulative travel risk information to the user FB information generation unit 73.

The user feedback (FB) information generation unit 73 generates user FB information on the basis of the cumulative travel risk information supplied from the cumulative travel risk information calculation unit 71, and transmits the user FB information to the smartphone 42 possessed by the insurance subscriber.

More specifically, the user FB information generation unit 73 obtains a cashback amount on the basis of the cumulative travel risk information in which various detection results regarding driving actions of the insurance subscriber are scored.

The user FB information generation unit 73 generates the driving habit improvement advice on the basis of the cumulative travel risk information.

The user FB information generation unit 73 generates the user FB information from the cumulative travel risk information, the cashback amount, and the driving habit improvement advice, and transmits the user FB information to the smartphone 42 possessed by the driver who is the insurance subscriber.

The insurance subscriber possessing the smartphone 42 can recognize the cashback amount corresponding to the cumulative travel risk information based on his/her own driving habit by visually recognizing the presented user FB information.

Furthermore, since the driving habit improvement advice is presented, the insurance subscriber can drive while being aware of the driving habit improvement advice, and it is possible to reduce the cumulative travel risk information and to aim for a larger cashback amount.

However, in the PHYD automobile insurance system 11 of FIG. 1, it is difficult to present how much subscription to the PHYD automobile insurance has contributed to reduction of occurrence of accidents in the entire society although it is possible to present the cumulative travel risk information, the cashback amount, and the driving habit improvement advice for the individual insurance subscriber by presenting the user FB information to the driver who is the insurance subscriber.

That is, in a current situation, it is possible to appeal the insurance premium of the PHYD automobile insurance as an insurance product that provides cashback by being aware to improve the driving habit, but it is difficult to appeal the high degree of contribution to society that the PHYD automobile insurance is an insurance product that can reduce accidents occurring in the entire society by improving the driving habits of all the insurance subscribers in terms of improving the marketing value.

Furthermore, in practice, it is difficult to present how much cashback is provided by improving the driving habits of all the insurance subscribers, and transparency of cash flow is not secured. Thus, it is difficult for the insurance subscribers to recognize whether the cashback has been appropriately provided when improving the driving habit as a whole.

Therefore, in the present disclosure, the PHYD automobile insurance system or the like enables the insurance subscribers to recognize how much an accident occurrence risk has been reduced in the entire society, that is, how much social contribution, such as reduction of occurrence of accidents, to the entire society has been achieved by behavior modification related to the driving habits of all the insurance subscribers.

Therefore, it is possible to encourage the insurance subscriber to modify behavior related to a risk factor in an insurance contract to behavior with a lower risk.

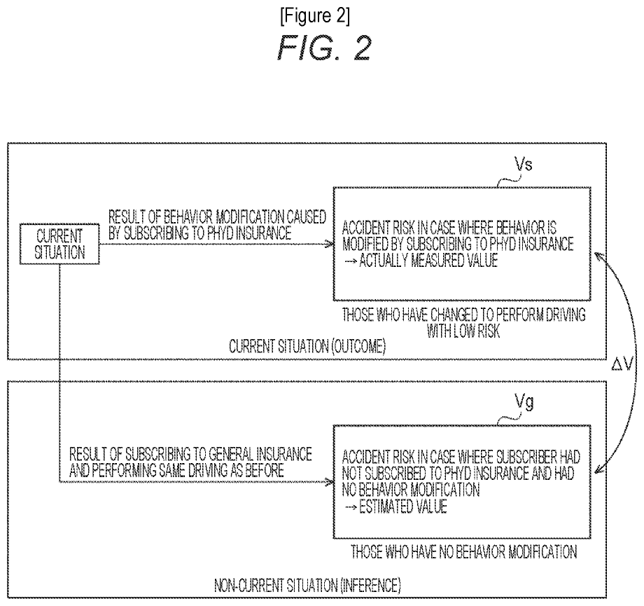

More specifically, in the present disclosure, as illustrated in FIG. 2, an estimated value Vg of an accident risk (which is an unrealistic inference) in a state where there is no behavior modification of the entire insurance subscribers is estimated, and a difference from an actually measured value Vs of an accident risk (which is an outcome of a current situation) when the behavior modification of the entire current (actual) insurance subscribers occurs is obtained as an index ΔV indicating a degree of reduction of occurrence of accidents in the entire society according to the behavior modification, and is visualized and presented to the insurance subscribers.

Therefore, it is possible to present the accident risk that could be reduced by all the PHYD insurance subscribers as the specific index ΔV, and it is possible to recognize the degree of social contribution by all the insurance subscribers of the entire PHYD automobile insurance.

Furthermore, by being presented as the cashback in conjunction with the index ΔV indicating the degree of reduction of occurrence of accidents in the entire society according to the behavior modification of the entire insurance subscriber, it is possible to cause the insurance subscribers to recognize that the cashback is appropriately provided due to improvement of the driving habits of all the insurance subscribers, and thus, it is possible to appeal the transparency of the cash flow.

As a result, it is possible to make a subscriber to indirectly recognize a sense of superiority or a sense of achievement in practicing social contribution through subscription to the PHYD automobile insurance, and it is possible to encourage behavior modification toward driving with more safety awareness.

Moreover, it is possible to encourage the subscriber to change an action toward driving with a lower accident risk in terms of behavioral economics and contribute to taking a user with a low accident risk in the PHYD automobile insurance, and thus, it is possible to mitigate payment of insurance money of the insurance company, thereby achieving reasonable improvement in balance of the insurance company at a low cost.

### 2. Preferred Embodiment

### Configuration Example of PHYD Automobile Insurance System of Present Disclosure

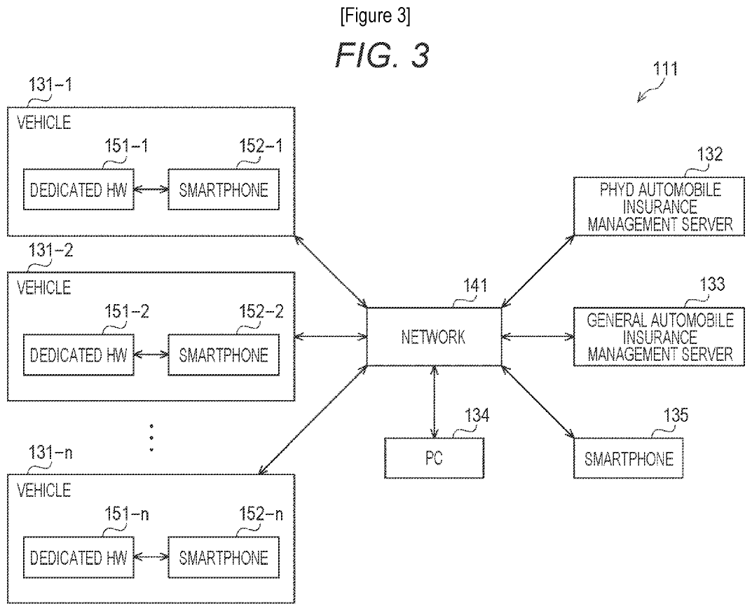

Next, a configuration example of a preferred embodiment of the PHYD automobile insurance system of the present disclosure will be described with reference to FIG. 3.

A PHYD automobile insurance system 111 in FIG. 3 includes vehicles 131-1 to 131-n, a PHYD automobile insurance management server 132, a general automobile insurance management server 133, a PC 134, and a smartphone 135 which are connected to each other via a network 141 including the Internet and a public line.

Each of the vehicles 131-1 to 131-n has a configuration corresponding to the vehicle 31 in FIG. 1, and is the vehicle driven by an insurance subscriber.

The vehicles 131-1 to 131-n include dedicated HW (Hardwear) 151-1 to 151-n and smartphones 152-1 to 152-n, respectively.

Note that, hereinafter, the vehicles 131-1 to 131-n, the dedicated HW (Hardwear) 151-1 to 151-n, and the smartphones 152-1 to 152-n will be simply referred to as a vehicle 131, a dedicated HW (Hardwear) 151, and a smartphone 152, respectively, in a case where it is not particularly necessary to distinguish them.

The dedicated HW 151 and the smartphone 152 have configurations corresponding to the dedicated HW 41 and the smartphone 42 in FIG. 1, respectively.

That is, the dedicated HW 151 and the smartphone 152 are configured to be capable of communicating with each other by near field communication such as Bluetooth (registered trademark).

The dedicated HW 151 is, for example, distributed from an insurance company that manages and operates a PHYD automobile insurance service to the insurance subscriber and mounted on the vehicle 131, and includes various sensors, such as an acceleration sensor and an angular velocity sensor, configured to recognize a driving action of the vehicle 31 by the driver who is the insurance subscriber.

The dedicated HW 151 detects an action of the vehicle 131, that is, information such as an acceleration and angular velocity related to the action of the vehicle 131 when driven by the driver on the basis of detection results of the various sensors, generates sensor information and measurement meta-information according to a detection result, and generates the sensor information and measurement meta-information to the smartphone 152.

The dedicated HW 151 detects, for example, the presence or absence of vibration, or the like to detect the start and stop of an engine, and transmits the detection result to the smartphone 152.

The smartphone 152 is a portable terminal carried by the insurance subscriber who is the driver, calculates a score according to the detection result as single travel risk information on the basis of information on the start and stop of the engine and the detection result indicating an action of the driver including the sensor information and the measurement meta-information transmitted from the dedicated HW 151, and transmits the calculated single travel risk information to the PHYD automobile insurance management server 132 via the network 141.

Furthermore, the smartphone 152 receives and presents cumulative travel risk information, a cashback amount, and driving habit improvement advice transmitted from the PHYD automobile insurance management server 132 via the network 141 according to the single travel risk information.

The PHYD automobile insurance management server 132 has a configuration corresponding to the PHYD automobile insurance company server 32 in FIG. 1, and generates information such as the cumulative travel risk information, the cashback amount, and the driving habit improvement advice on the basis of the single travel risk information transmitted from the smartphone 152, and transmits the generated information to the smartphone 152.

The PHYD automobile insurance management server 132 calculates a reduced claim cost according to changes an actions of all PHYD automobile insurance subscribers on the basis of information regarding an accident occurrence likelihood, a total number of insurance subscribers, and a claim cost in a general automobile insurance, supplied from the general automobile insurance management server 133 in addition to the single travel risk information transmitted from the smartphone 152, generates information for presenting the reduced claim cost, and supplies the information to the smartphone 152 via the network 141. Furthermore, the information for presenting the reduced claim cost is also information that can be browsed by a general user on the PC 134, the smartphone 135, or the like.

The general automobile insurance management server 133 is a server managed and operated by, for example, an association that manages the general automobile insurance such as a pay as you drive (PAYD) automobile insurance that is not the PHYD automobile insurance, and supplies information regarding an accident occurrence likelihood, a total number of insurance subscribers, and the claim cost in the general automobile insurance to the PHYD automobile insurance management server 132.

Note that the claim cost referred to herein is, for example, an expected value per unit time of accident losses, such as insurance money generated by an accident, in a general automobile insurance service and the PHYD automobile insurance service, and indicates an expected value per unit time of a cost that is an expense for the insurance company in implementing the automobile insurance service.

That is, in the PHYD automobile insurance service, the claim cost is reduced when the number of accidents is reduced as a whole due to behavior modification of the insurance subscribers, and thus, it is devised to reflect (a part of) such a reduced claim cost in the cashback.

Furthermore, hereinafter, automobile insurance services other than the PHYD automobile insurance service, such as a pay as you drive (PAYD) automobile insurance service, in which a claim cost does not change depending on behavior modification of an insurance policyholder or an insurance subscriber (the claim cost is not expected to change) are collectively referred to as the general automobile insurance service.

### Configuration Example of Smartphone

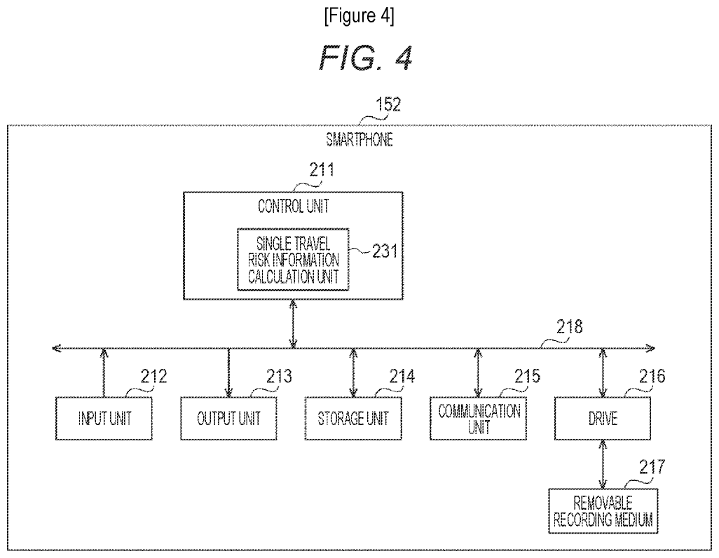

Next, a configuration example of the smartphone 152 will be described with reference to FIG. 4.

The smartphone 152 includes a control unit 211, an input unit 212, an output unit 213, a storage unit 214, a communication unit 215, a drive 216, and a removable storage medium 217 which are connected to each other via a bus 218 and can transmit and receive data and a program.

The control unit 211 includes a processor and a memory, and controls the entire operation of the smartphone 152. Furthermore, the control unit 211 further includes a single travel risk information calculation unit 231.

The single travel risk information calculation unit 231 has a configuration corresponding to the single travel risk information calculation unit 51 in FIG. 1, and calculates a habit of one-time driving of the insurance subscriber, who is the driver of the vehicle 131, on the basis of the detection result indicating the action of the driver including the sensor information and the measurement meta-information transmitted from the dedicated HW 151 as a single travel risk.

The single travel risk information calculation unit 231 sets a score according to, for example, whether or not a frequency of a sudden acceleration or sudden stop is more than a predetermined number of times, whether or not an occurrence frequency of a state in which an acceleration in a left-right direction at the time of making a right turn and a left turn is larger than a predetermined value is more than a predetermined number of times, and calculates a driving habit of the insurance subscriber who is the driver as a travel risk, and calculates a cumulative value thereof as time passes.

For example, the single travel risk information calculation unit 231 regards a time from the start timing to the stop timing of the engine, supplied from the dedicated HW 151, as one travel time, obtains the single travel risk per unit time by dividing an accumulated score of the travel risk within one travel time by the travel time, and transmits the single travel risk to the PHYD automobile insurance management server 132 as unit travel risk information.

The input unit 212 includes an input device such as a keyboard and a mouse through which the user inputs an operation command, and supplies various input signals to the control unit 211.

The output unit 213 is controlled by the control unit 211, and outputs supplied operation screen and image of a processing result to a display device including a liquid crystal display (LCD), an organic electro luminescence (EL), or the like for display.

The storage unit 214 includes a hard disk drive (HDD), a solid state drive (SSD), a semiconductor memory, or the like, is controlled by the control unit 211, and writes or reads various pieces of data and programs.

The communication unit 215 is controlled by the control unit 211, and transmits and receives various pieces of data and programs to and from various devices via a communication network represented by a local area network (LAN) or the like in a wired (or wireless (not illustrated)) manner.

The drive 216 reads and writes data from and to the removable storage medium 217 such as a magnetic disc (including a flexible disc), an optical disc (including a compact disc-read only memory (CD-ROM) and a digital versatile disc (DVD)), a magneto-optical disc (including a mini disc (MD)), or a semiconductor memory.

### Configuration Example of PHYD Automobile Insurance Management Server

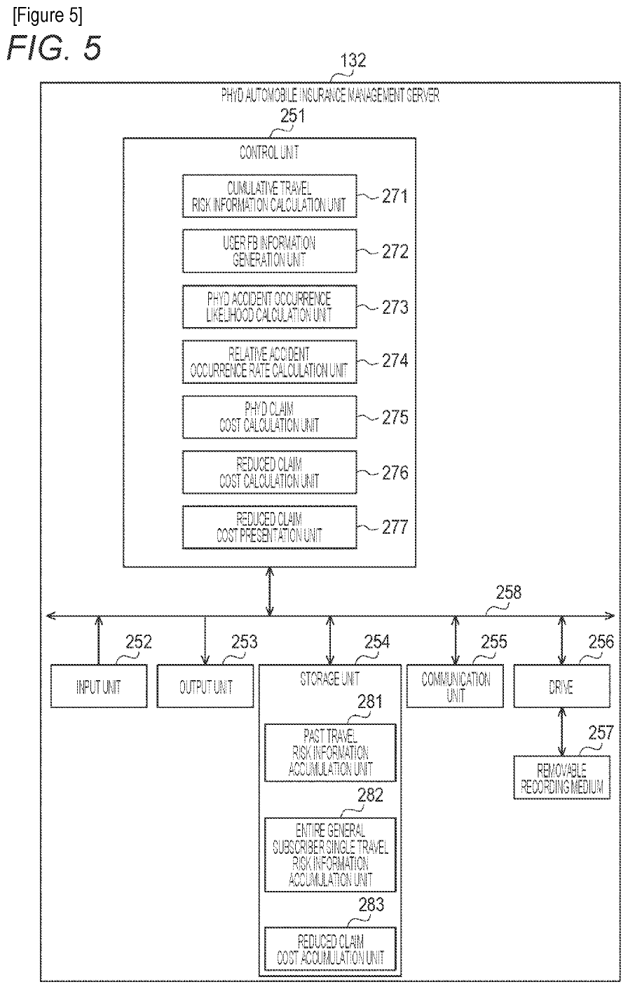

Next, a configuration example of the PHYD automobile insurance management server 132 will be described with reference to FIG. 5.

The PHYD automobile insurance management server 132 includes a control unit 251, an input unit 252, an output unit 253, a storage unit 254, a communication unit 255, a drive 256, and a removable storage medium 257 which are connected to each other via a bus 258 and can transmit and receive data and programs.

The control unit 251 includes a processor and a memory, and controls the entire operation of the PHYD automobile insurance management server 132.

The control unit 251 includes a cumulative travel risk information calculation unit 271, a user feedback (FB) information generation unit 272, a PHYD accident occurrence likelihood calculation unit 273, a relative accident occurrence rate calculation unit 274, a PHYD claim cost calculation unit 275, a reduced claim cost calculation unit 276, and a reduced claim cost presentation unit 277.

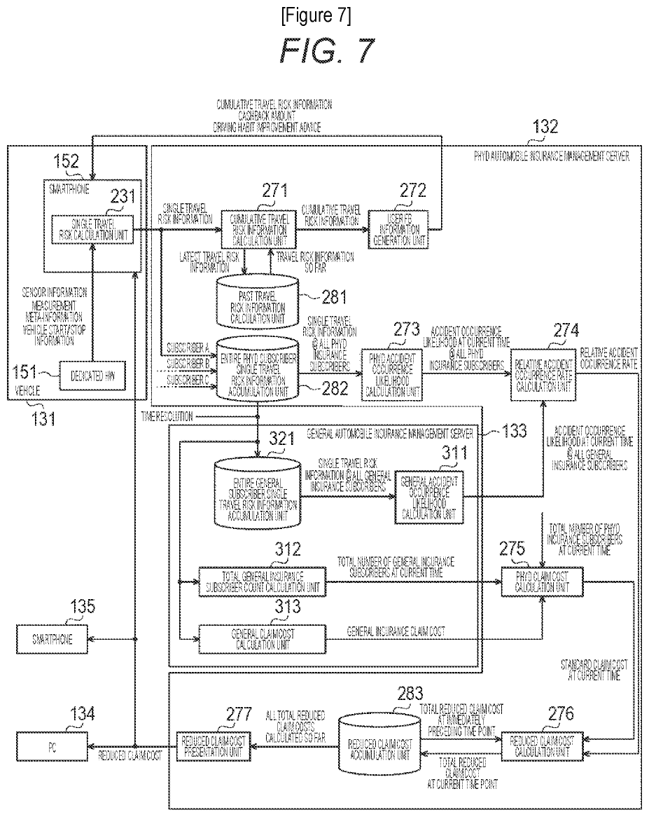

Note that the cumulative travel risk information calculation unit 271, the user feedback (FB) information generation unit 272, the PHYD accident occurrence likelihood calculation unit 273, the relative accident occurrence rate calculation unit 274, the PHYD claim cost calculation unit 275, the reduced claim cost calculation unit 276, and the reduced claim cost presentation unit 277 will be described later in detail with reference to FIG. 7.

The input unit 252 includes an input device such as a keyboard and a mouse through which the user inputs an operation command, and supplies various input signals to the control unit 251.

The output unit 253 is controlled by the control unit 251, and outputs supplied operation screen and image of a processing result to a display device including a liquid crystal display (LCD), an organic electro luminescence (EL), or the like for display.

The storage unit 254 includes a hard disk drive (HDD), a solid state drive (SSD), a semiconductor memory, or the like, is controlled by the control unit 251, and writes or reads various pieces of data and programs.

The storage unit 254 includes a past travel risk information accumulation unit 281, an entire PHYD subscriber single travel risk information accumulation unit 282, and a reduced claim cost accumulation unit 283.

Note that the past travel risk information accumulation unit 281, the entire PHYD subscriber single travel risk information accumulation unit 282, and the reduced claim cost accumulation unit 283 will be described later in detail with reference to FIG. 7.

The communication unit 255 is controlled by the control unit 251, and transmits and receives various pieces of data and programs to and from various devices via a communication network represented by a local area network (LAN) or the like in a wired (or wireless (not illustrated)) manner.

The drive 256 reads and writes data from and to the removable storage medium 257 such as a magnetic disc (including a flexible disc), an optical disc (including a compact disc-read only memory (CD-ROM) and a digital versatile disc (DVD)), a magneto-optical disc (including a mini disc (MD)), or a semiconductor memory.

### Configuration Example of General Automobile Insurance Management Server

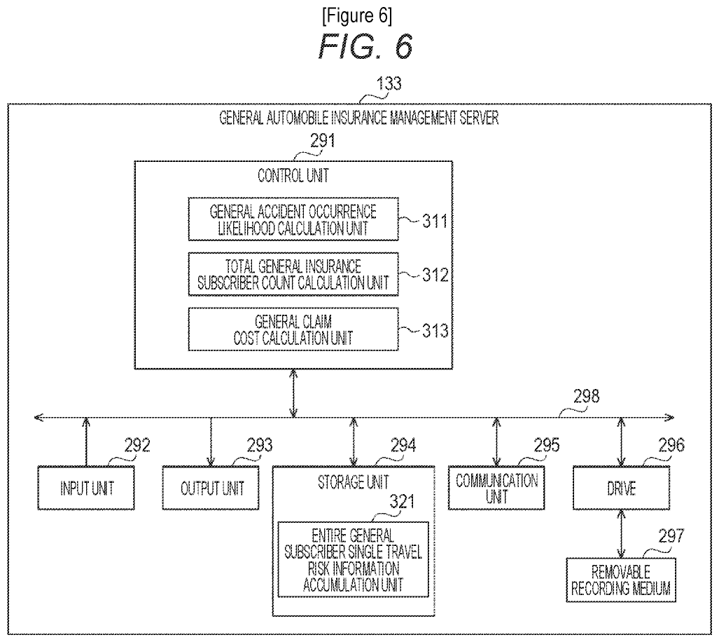

Next, a configuration example of the general automobile insurance management server 133 will be described with reference to FIG. 6.

The general automobile insurance management server 133 includes a control unit 291, an input unit 292, an output unit 293, a storage unit 294, a communication unit 295, a drive 296, and a removable storage medium 297 which are connected to each other via a bus 298 and can transmit and receive data and programs.

The control unit 291 includes a processor and a memory, and controls the entire operation of the general automobile insurance management server 133.

The control unit 291 includes a general accident occurrence likelihood calculation unit 311, a total general insurance subscriber count calculation unit 312, and a general claim cost calculation unit 313.

Note that the general accident occurrence likelihood calculation unit 311, the total general insurance subscriber count calculation unit 312, and the general claim cost calculation unit 313 will be described later in detail with reference to FIG. 7.

The input unit 292 includes an input device such as a keyboard and a mouse through which the user inputs an operation command, and supplies various input signals to the control unit 291.

The output unit 293 is controlled by the control unit 291, and outputs supplied operation screen and image of a processing result to a display device including a liquid crystal display (LCD), an organic electro luminescence (EL), or the like for display.

The storage unit 294 includes a hard disk drive (HDD), a solid state drive (SSD), a semiconductor memory, or the like, is controlled by the control unit 291, and writes or reads various pieces of data and programs.

The storage unit 294 includes an entire general subscriber single travel risk information accumulation unit 321.

Note that the entire general subscriber single travel risk information accumulation unit 321 will be described later in detail with reference to FIG. 7.

The communication unit 295 is controlled by the control unit 291, and transmits and receives various pieces of data and programs to and from various devices via a communication network represented by a local area network (LAN) or the like in a wired (or wireless (not illustrated)) manner.

The drive 296 reads and writes data from and to the removable storage medium 297 such as a magnetic disc (including a flexible disc), an optical disc (including a compact disc-read only memory (CD-ROM) and a digital versatile disc (DVD)), a magneto-optical disc (including a mini disc (MD)), or a semiconductor memory.

### Functions Implemented by PHYD Automobile Insurance System of FIG. 3

Next, functions implemented by the PHYD automobile insurance system 111 of FIG. 3 will be described with reference to a functional block diagram of FIG. 7.

In the smartphone 152 of each of the vehicles 131, the single travel risk information calculation unit 231 calculates various scores constituting the single travel risk information on the basis of detection results of the dedicated HW 151, and transmits the scores to the PHYD automobile insurance management server 132.

More specifically, the single travel risk information calculation unit 231 calculates a detection result according to a model at the time of calculating an insurance premium as a single travel risk.

The single travel risk is the number of times of occurrence of an action that is likely to affect a travel risk (risk of occurrence of an accident that requires payment of insurance money) or a value per unit time, unit distance, or the like related to an occurrence frequency of the action.

More specifically, the single travel risk includes, for example, the number of times of occurrence of a predetermined action related to the travel risk (hereinafter, simply referred to as a predetermined action) (the number of times of the action), an occurrence frequency per unit time at which the predetermined action occurs (an action occurrence unit time frequency), an occurrence frequency per unit distance at which the predetermined action occurs (action occurrence unit distance frequency), a proportion in a unit time or unit distance at which a state satisfying a plurality of conditions related to the predetermined action is continued, and the like.

Here, the predetermined action related to the travel risk is an action associated with a risk that is likely to occur during travel, for example, a sudden acceleration caused by acceleration larger than a predetermined acceleration and a gentle acceleration caused by acceleration smaller than the predetermined acceleration; a sudden deceleration that is deceleration larger than a predetermined acceleration and a gentle deceleration that is deceleration smaller than the predetermined acceleration; right and left turns in which an acceleration larger than a predetermined acceleration is applied in the left-right direction and right and left turns in which an acceleration smaller than the predetermined acceleration is applied in the left-right direction; and the like.

Note that the single travel risk is not limited thereto as long as it is a value or score according to an action that is likely to affect the travel risk.

Hereinafter, the value or score expressed as the single travel risk, and a combination of the both are also referred to as the single travel risk information.

Therefore, the single travel risk information calculation unit 231 calculates the above-described single travel risk, and transmits the calculated value or score to the PHYD automobile insurance management server 132 as the single travel risk information.

The cumulative travel risk information calculation unit 271 in the PHYD automobile insurance management server 132 has a configuration corresponding to the cumulative travel risk information calculation unit 71 in FIG. 1, acquires the single travel risk information transmitted from the single travel risk information calculation unit 231 of the smartphone 152 possessed by the insurance subscriber who drives the vehicle 131, and then, cumulatively accumulates the single travel risk information in the past travel risk information accumulation unit 281 to form past travel risk information.

The cumulative travel risk information calculation unit 271 adds the past travel risk information cumulatively accumulated in the past travel risk information accumulation unit 281 and the acquired single travel risk information to calculate a cumulative travel risk at the current time and supplies the cumulative travel risk information to the user FB information generation unit 272.

The user feedback (FB) information generation unit 272 has a configuration corresponding to the user FB information generation unit 73 in FIG. 1, generates user FB information on the basis of the cumulative travel risk information supplied from the cumulative travel risk information calculation unit 271, and transmits the user FB information to the smartphone 152 possessed by the insurance subscriber.

The user FB information generation unit 272 sets a cashback amount on the basis of the cumulative travel risk information, that is, on the basis of values and scores for various detection results indicating driving actions constituting the obtained cumulative travel risk information.

The user FB information generation unit 272 generates driving habit improvement advice on the basis of the cumulative travel risk information.

That is, for example, in a case where it is recognized in the cumulative travel risk information that there are a lot of sudden accelerations and sudden decelerations, the user FB information generation unit 272 notifies that there are a lot of sudden accelerations and sudden decelerations in a driving habit, and generates driving habit improvement advice for consciously reducing the sudden acceleration and the sudden deceleration.

For example, in a case where it is recognized in the cumulative travel risk information that the number of times an acceleration in the left-right direction at the time of making a right turn or a left turn exceeds a predetermined value is larger than a predetermined number of times, the user FB information generation unit 73 notifies that the number of times the acceleration in the left-right direction at the time of making the right turn or the left turn exceeds the predetermined value is larger than the predetermined number, and generates driving habit improvement advice for preventing the acceleration in the left-right direction at the time of making the right turn or the left turn from exceeding the predetermined value.

The user FB information generation unit 272 generates the user FB information including the cumulative travel risk information, the cashback amount, and the driving habit improvement advice, and transmits the user FB information to the smartphone 152 possessed by the driver who is the insurance subscriber.

When acquiring the user FB information including the cumulative travel risk value, the cashback amount, and the driving habit improvement advice from the user FB information generation unit 272 of the PHYD automobile insurance management server 132, the smartphone 152 presents the user FB information to the user.

With such presentation, the user can grasp his/her own driving habit and the cashback amount, and can recognize a point at which his/her own driving habit needs to be improved in order to acquire a further cashback amount through the driving habit improvement advice.

The entire PHYD subscriber single travel risk information accumulation unit 282 accumulates pieces of the single travel risk information of all the subscribers supplied from the smartphones 152 in the plurality of vehicles 131 driven by the insurance subscribers who subscribe to the PHYD automobile insurance.

The PHYD accident occurrence likelihood calculation unit 273 calculates a PHYD accident occurrence likelihood, which is an accident occurrence likelihood in the entire PHYD automobile insurance subscriber, on the basis of pieces of the single travel risk information of all the subscribers of the PHYD automobile insurance (all the PHYD insurance subscribers) from the present to the immediately preceding timing by a predetermined unit time (corresponding to a time resolution) accumulated in the entire PHYD subscriber single travel risk information accumulation unit 282, and outputs the PHYD accident occurrence likelihood to the relative accident occurrence rate calculation unit 274.

The PHYD accident occurrence likelihood is, for example, a value set by dividing each piece of the single travel risk information of the entire PHYD subscriber by a time from the present to the immediately preceding timing by the predetermined unit time (corresponding to the time resolution) and integrates results of the division.

Furthermore, the PHYD accident occurrence likelihood may be a value set by dividing each piece of the single travel risk information of the entire PHYD subscriber by a mileage from the present to the immediately preceding timing by the predetermined unit time (corresponding to the time resolution) and adds up results of the division.

The entire general subscriber single travel risk information accumulation unit 321 of the general automobile insurance management server 133 accumulates single travel risk information of each subscriber who subscribes to the general automobile insurance.

The general accident occurrence likelihood calculation unit 311 calculates a general accident occurrence likelihood, which is an accident occurrence likelihood in the entire general automobile insurance subscriber, on the basis of pieces of the single travel risk information of all the subscribers of the general automobile insurance (all the general subscribers) from the present to the immediately preceding timing by a predetermined unit time (corresponding to the time resolution) accumulated in the entire general subscriber single travel risk information accumulation unit 321, and outputs the general accident occurrence likelihood to the relative accident occurrence rate calculation unit 274.

The general accident occurrence likelihood is a value corresponding to the PHYD accident occurrence likelihood, and is, for example, a value set by dividing each piece of the single travel risk information of the entire general subscriber by a time from the present to the immediately preceding timing by the predetermined unit time (corresponding to the time resolution) and integrates results of the division.

Furthermore, the general accident occurrence likelihood may be a value set by dividing each piece of the single travel risk information of the entire general subscriber by a mileage from the present to the immediately preceding timing by the predetermined unit time (corresponding to the time resolution) and adds up results of the division.

The relative accident occurrence rate calculation unit 274 calculates an accident occurrence rate of the insurance subscribers subscribing to the PHYD automobile insurance at the current time relative to the subscribers subscribing to the general automobile insurance as a relative accident occurrence rate on the basis of the PHYD accident occurrence likelihood supplied from the PHYD accident occurrence likelihood calculation unit 273 and the general accident occurrence likelihood supplied from the general accident occurrence likelihood calculation unit 311, and outputs the calculated relative accident occurrence rate to the reduced claim cost calculation unit 276.

For example, the relative accident occurrence rate calculation unit 274 may calculate the relative accident occurrence rate by calculating the following Formula (1).

$$[ Formula 1 ]$$

$${P}_{PHYD} ( t ) = exp \{ {\sum }_{j = 0}^{{N}_{PHYD} ( t )} {[ \frac{{\sum }_{i = 0} \{ {S}_{PHYD , i} \}}{{\sum }_{i = 0} \{ {T}_{PHYD , i} \}} ]}_{j} \} / exp \{ {\sum }_{l = 0}^{{N}_{Common} ( t )} {[ \frac{{\sum }_{i = 0} \{ {S}_{Common , k} \}}{{\sum }_{i = 0} \{ {T}_{Common , k} \}} ]}_{l} \} \qquad ( 1 )$$

Here, P_{PHYD}(t) is a relative accident occurrence rate which is an accident occurrence rate of the insurance subscribers of the PHYD automobile insurance at the current time with respect to the insurance subscribers subscribing to the general automobile insurance.

S_{PHYD} is a single travel risk of each individual of the PHYD automobile insurance subscribers, and S_{common} is a single travel risk of each individual of the general automobile insurance subscribers.

T_{PHYD} is a travel time (time corresponding to the time resolution) when the single travel risk of each individual of the PHYD automobile insurance subscribers is obtained, and T_{Common} is a travel time (time corresponding to the time resolution) when the single travel risk of each individual of the general automobile insurance subscribers is obtained.

N_{PHYD} is the number of subscribers subscribing to the PHYD automobile insurance (the total number of subscribers of the PHYD automobile insurance), and N_{Common} is the number of insurance subscribers subscribing to the general automobile insurance (the total number of subscribers of the general automobile insurance).

Note that, here, the single travel risk information is based on the following first to third assumptions.

The first assumption of the single travel risk information is that a dominant factor of an accident is a driving manner (driving habit).

The second assumption of the single travel risk is that the total number of insurance subscribers subscribing to the general automobile insurance service is enormous, and thus, is regarded as a gathering of groups having non individuality since there is no large individual difference in driving habit and the like in the case of being viewed as a cluster.

The third assumption of the single travel risk is that the driving habit of the total number of insurance subscribers subscribing to the general automobile insurance service does not basically change.

The first assumption is that a major cause of the accident is not greatly affected by information regarding which vehicle a driver is riding, a type of driver's license, and the like, but the driving habit (driving manner) is the dominant factor.

The second assumption is that, for example, assuming 1 million people who have subscribed to the general automobile insurance, there is naturally a difference in the driving habit and the like between the respective insurance subscribers, but it can be considered that an accident occurrence rate as the cluster matches even if 1 million people having individuality in the driving habit and 1 million people having no individuality in the driving habit are compared.

The third assumption is that there is no significant yearly change in the driving habit in the case of subscribing to the general automobile insurance in which a claim cost does not change depending on behavior modification of the insurance subscriber and an incentive such as cashback does not exist.

Formula (1) is a formula for obtaining the relative accident occurrence rate using an insurance premium rate model based on an accident occurrence likelihood using a single travel risk defined with the first assumption to the third assumption as a value per unit time.

In Formula (1), a Poisson distribution is used as a model used for regression calculation when an estimated accident occurrence likelihood is calculated, and an exponential function having a natural logarithm as a base is used as a link function.

More specifically, the numerator of Formula (1) is an average value of accident occurrence likelihoods (PHYD accident occurrence likelihoods) of all the PHYD automobile insurance subscribers within a unit time, and the denominator of Formula (1) is an average value of accident occurrence likelihoods (general accident occurrence likelihoods) of all the subscribers of the general automobile insurance within the unit time.

That is, in Formula (1), a relative change in the accident occurrence rate of the entire PHYD automobile insurance subscriber with respect to the entire general automobile insurance subscriber is estimated by a log ratio based on the natural logarithm of the average value, which is the numerator, of the accident occurrence likelihoods of all the PHYD automobile insurance subscribers within the unit time and the average value, which is the denominator of Formula (1), of the estimated accident occurrence likelihoods of all the general automobile insurance subscribers within the unit time.

Note that, when an average of accident occurrence probabilities of all the PHYD automobile insurance subscribers is to be obtained, a weighted average according to a mileage or the like may be used, or only a single travel risk of the PHYD automobile insurance subscriber satisfying a predetermined condition may be used.

Furthermore, a formula for obtaining the relative accident occurrence rate may be a formula other than Formula (1), and other calculation formulas may be used as long as a model similar to an actual insurance premium rate model is used for the numerator and denominator as illustrated in Formula (1).

Moreover, when the average value of the accident occurrence rates of all the general automobile insurance subscribers, which is the denominator in Formula (1), is to be obtained, a fixed value, measured in advance from subscribers who are subscribing to the general automobile insurance, may be used on the basis of the first assumption to the third assumption described above.

The total general insurance subscriber count calculation unit 312 of the general automobile insurance management server 133 outputs information regarding a total number of general automobile insurance subscribers at the current time to the PHYD claim cost calculation unit 275.

The general claim cost calculation unit 313 calculates a claim cost of the general automobile insurance, and outputs the claim cost to the PHYD claim cost calculation unit 275.

The PHYD claim cost calculation unit 275 calculates a PHYD claim cost, which is a claim cost of the PHYD automobile insurance at the current time, on the basis of information regarding the total number of subscribers of the PHYD automobile insurance in addition to the information regarding the total number of subscribers of the general automobile insurance supplied from the total general insurance subscriber count calculation unit 312 and the claim cost of the general automobile insurance supplied from the general claim cost calculation unit 313, and outputs the PHYD claim cost to the reduced claim cost calculation unit 276.

More specifically, the PHYD claim cost calculation unit 275 calculates an estimated value of the PHYD claim cost, for example, by calculating the following Formula (2).

$$[ Formula 2 ]$$

$${C}_{PHYD PSUEDO} ( t ) = \frac{{N}_{PHYD} ( t )}{{N}_{Common} ( t )} \cdot {C}_{Common} ( t ) \qquad ( 2 )$$

Here, C_{PHYD PSUEDO}(t) is an estimated value of the PHYD claim cost which is a claim cost per unit time in a case where the PHYD automobile insurance subscriber does not change an action, and C_{Common}(t) is a claim cost per unit time of the normal automobile insurance subscriber.

N_{PHYD}(t) is the total number of insurance subscribers of the PHYD automobile insurance at the current time, and N_{Common}(t) is the total number of insurance subscribers of the general automobile insurance.

That is, in a case where the major cause of the accident is the driving habit and general insurance policyholders are viewed in the entire county, the driving habit does not change but is uniform, and there is no large change basically. Thus, on the basis of the first assumption to the third assumption, it can be regarded that the accident occurrence rate of the general automobile insurance varies only depending on the number of subscribers, and the accident occurrence rate and the claim cost of the entire cluster are proportional only to the number of subscribers.

Therefore, for example, assuming that the total number of insurance subscribers who have subscribed to the PHYD automobile insurance at the current time is 10,000, the total number of insurance subscribers who have subscribed to the general automobile insurance is 1 million, and the claim cost per unit time for all the insurance subscribers who have subscribed to the general automobile insurance (an expected value of accident losses that may be generated per hour) is 100,000 yen, a claim cost in a case where all the 10,000 insurance subscribers to the PHYD automobile insurance have not corrected their own driving habits (have not subscribed to the insurance) is 1000 yen.

This is expressed as Formula (2) described above.

The reduced claim cost calculation unit 276 calculates a reduced claim cost at the current time on the basis of the relative accident occurrence rate supplied from the relative accident occurrence rate calculation unit 274 and the PHYD claim cost supplied from the PHYD claim cost calculation unit 275, and accumulates the reduced claim cost in the reduced claim cost accumulation unit 283.

More specifically, the reduced claim cost calculation unit 276 calculates the reduced claim cost at the current time by calculating the following Formula (3) on the basis of the relative accident occurrence rate supplied from the relative accident occurrence rate calculation unit 274 and the PHYD claim cost supplied from the PHYD claim cost calculation unit 275.

[Formula 3]

C_{PHYD}=∫_{T}_{ₛₜₐᵣₜ}^{T}^{_{end}}[P_{PHYD}(t)·C_{PHYD PSUEDO}(t)]dt (3)

Here, C_{PHYD} is an estimated value of a claim cost reduced by all the PHYD automobile insurance subscribers from an aggregation start to the current time, and C_{PHYD PSUEDO}(t) is an estimated value of a claim cost at the current time in a case where there is no behavior modification of the PHYD automobile insurance subscriber.

P_{PHYD}(t) is a relative accident occurrence rate, Tₛₜₐᵣₜ is an aggregation start time (insurance product release time), and Tₛₜₐᵣₜ is an aggregation end time (current time).

This C_{PHYD PSUEDO}(t) is the claim cost at the current time in the case where there is no behavior modification of the PHYD automobile insurance subscribers, in other words, a claim cost per unit time in a case where the PHYD automobile insurance subscribers subscribe to the general insurance.

Formula (3) is a formula for estimation of how much the claim cost per unit time in the case where the PHYD insurance subscribers subscribe to the general insurance varies due to improvement in the driving habit of each individual of the PHYD insurance subscribers, in other words, an expected value of the claim cost reduced by all the PHYD insurance subscribers.

Therefore, according to Formula (3), an expected value of a sum of the claim cost reduced by improvement (behavior modifications) in driving habits of all subscribers who have subscribed to the PHYD automobile insurance so far at an arbitrary timing or in an arbitrary time section is calculated.

Therefore, the reduced claim cost calculated every day by the reduced claim cost calculation unit 276 can be regarded as an accident reduction effect per day.

Note that, in other words, the relative accident occurrence rate P_{PHYD} in Formula (3) can be regarded as a proportion of an actually measured value Vs when an action is actually changed with respect to the estimated value Vg of the accident risk in the current situation where there is no behavior modification, which has been described with reference to FIG. 2, and is also a value corresponding to the index ΔV indicating the degree of reduction of occurrence of accidents in the entire society according to the behavior modification.

The reduced claim cost presentation unit 277 reads the reduced claim cost accumulated in the reduced claim cost accumulation unit 283, and creates and presents a moving image or the like indicating the reduced claim cost that can be presented by the PC 134 and the smartphone 135, for example.

### Examples of Moving Image Presenting Reduced Claim Cost

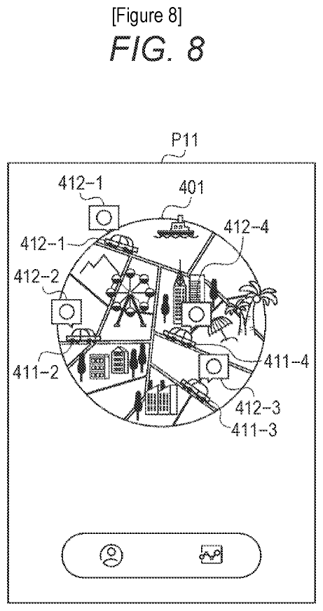

Next, examples of a moving image that presents a total reduced claim cost will be described with reference to FIGS. 8 to 12.

First, an image P11 as illustrated in FIG. 8 is displayed in which vehicles 411-1 to 411-4 are traveling on a map 401, and circled marks 412-1 to 412-4 appear on the vehicles 411-1 to 411-4. This expresses that a claim cost is reduced along with behavior modification of PHYD automobile insurance subscribers who drive the vehicles 411-1 to 411-4.

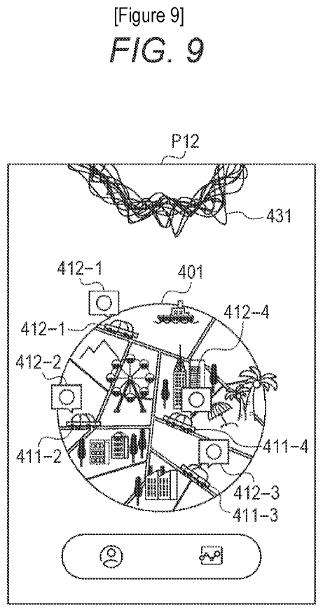

Next, an image P12 as illustrated in FIG. 9 is displayed, the map 401 moves downward in the image, an expression as a symbolic aggregate representing a claim cost at a time point before the behavior modification of the PHYD automobile insurance subscribers appears as a pattern 431 on the top in the image. This expression represents the claim cost of the entire subscriber before the behavior modification, and thus, is the pattern with distorted rings to enable a user to intuitively feel a high risk. Next, the circled marks 412-1 to 412-4 each indicating that the claim cost has been reduced along with the behavior modification are moved to converge to the pattern 431.

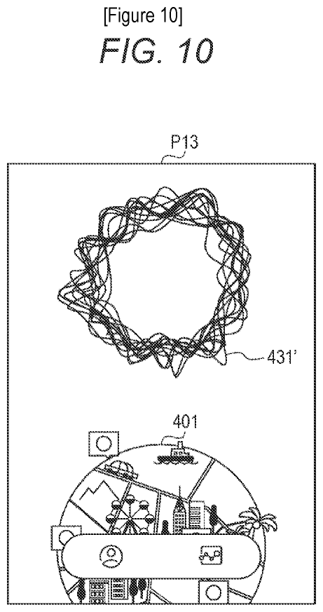

The image P12 transitions to an image P13 as illustrated in FIG. 10 together with the movement described with reference to FIG. 9. That is, the pattern 431 in the image P12 is completely displayed, and then, moves to a center position of the image while changing to a distorted ring-shaped pattern 431′, and the marks 412-1 to 412-4 in FIG. 9 converge to the pattern 431′. Moreover, an animation effect is executed such that the map 401 disappears from the bottom of the image.

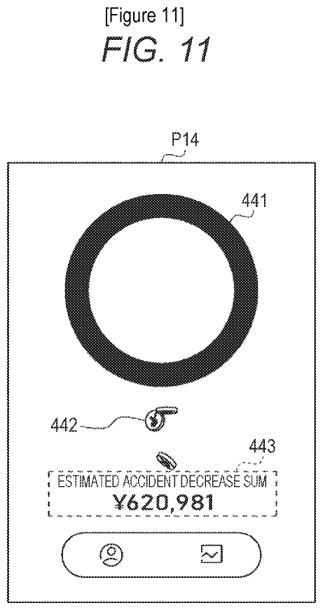

Thereafter, the pattern 431′ in the image P13 of FIG. 10 is changed to a pattern 441 in an image P14 of FIG. 11. This expresses the reduction in the claim cost of the entire subscriber by the change of the pattern 431′, which is the distorted ring expressing the claim cost at the high risk before the behavior modification, to the pattern 441 which is a ring close to a perfect circle due to the behavior modification of the PHYD automobile insurance subscribers. Along with this change, a pattern 442 indicating that coins expressing an accident reduction sum generated according to the reduced claim cost are generated is displayed from the pattern 441. Furthermore, at this time, a specific sum of the reduced claim cost in the latest unit time is displayed as a “estimated accident decrease sum” in a sum display field 443.

The sum display field 443 of FIG. 11 illustrates an example in which it is displayed that the estimated accident decrease sum, which is a specific sum per designated time resolution of the reduced claim cost, is 620,981 yen.

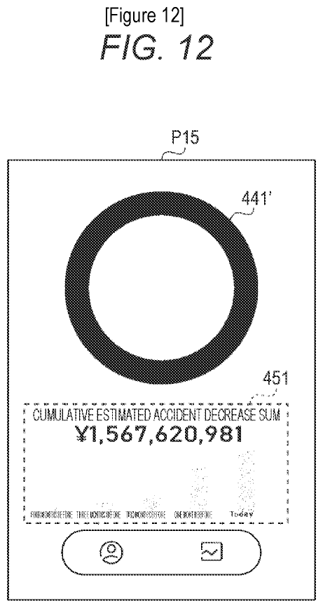

Then, an image P15 as illustrated in FIG. 12 is displayed, and a graph display field 451 of a cumulative estimated accident decrease sum, which is a specific sum of time-series reduced claim costs, is displayed together with a pattern 441 expressing the reduced claim cost. The graph display field 451 illustrates an example in which bar graphs each indicating a cumulative sum of claim costs reduced in time series from the left in the drawing, and that the cumulative estimated accident decrease sum is 1,567,620,981 yen are displayed.

That is, it is expressed that the behavior modification of each of the PHYD insurance-type insurance subscribers represented as the circled marks 412 of the vehicles 411 are gathered in the pattern 431 or 431′ by a series of the moving images as illustrated in the images P11 to P15 in FIGS. 8 to 12 to produce a result of suppressing the occurrence of the accident as expressed by the pattern 441, and the result is reflected as the estimated accident decrease sum expressed by the pattern 442.

At this time, an estimated accident decrease sum per unit time, a cumulative estimated accident reduction sum, and the like are specifically expressed by a numerical value, a graph, and the like by the sum display field 443, the graph display field 451, and the like.

With such presentation, the PHYD insurance-type insurance subscribers can feel a sense of co-creation that each of them works on contribution to society by reducing the number of accidents occurring in the entire society.

Furthermore, such presentation enables the PHYD insurance-type insurance subscriber to recognize a real-time effect achieved by his/her own behavior modification in real time on the basis of a specific numerical value, and to obtain a sense of making a change in society with behavior modification in daily life.

Moreover, such presentation enables the PHYD insurance-type insurance subscriber to specifically realize that the economic value is produced by reducing the number of accidents.

Furthermore, such presentation enables the PHYD insurance-type insurance subscriber to recognize that all efforts so far have been accumulated as indicated by the graph display field 451, and to specifically recognize how much the number of traffic accidents has been decreased.

As a result, the PHYD insurance-type insurance subscriber can simultaneously feel the economic superiority of the insurance premium through the cashback amount and the sense of achievement in realizing the social contribution of reducing the number of traffic accidents brought about by subscribing to the PHYD insurance-type insurance.

Furthermore, it is possible to appeal to a user who is interested in the PHYD insurance-type insurance and searches for the PHYD insurance-type insurance through the PC 134, the smartphone 135, or the like as an insurance product with which the economic superiority by the behavior modification and the accompanying sense of achievement in realizing the social contribution such as the reduction in the number of traffic accidents caused by the economic superiority.

Note that the series of moving images as illustrated by the images P11 to P15 in FIGS. 8 to 12 is merely examples to present the reduced claim cost, and the presentation may be performed by other methods.

However, the presentation of the reduced claim cost is desirably what is obtained by reflecting, as cashback, a result of suppressing the occurrence of an accident, produced by the combination of behavior modification of each of the PHYD insurance-type insurance subscribers, and is a content of collective intelligence, for example, in which the estimated accident decrease sum, the cumulative estimated accident reduction sum, and the like are specifically expressed.

### Reduced Claim Cost Presentation Processing

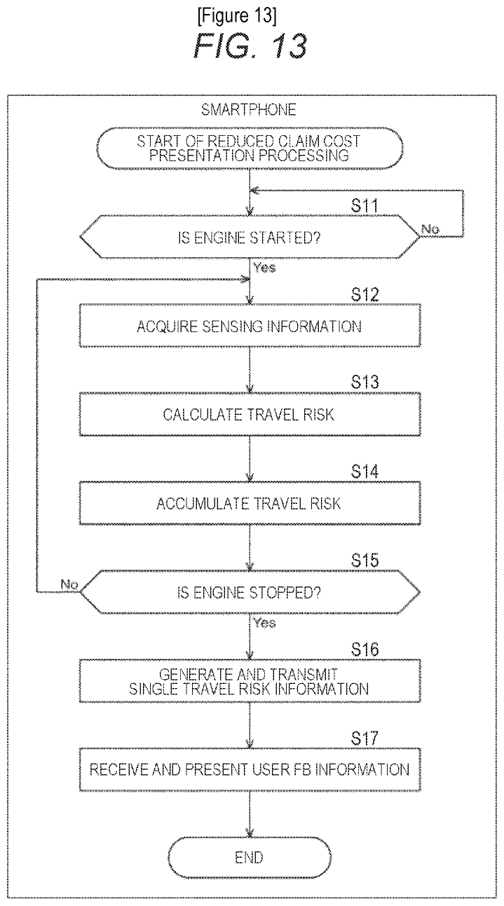

Next, reduced claim cost presentation processing will be described with reference to flowcharts of FIGS. 13 to 15.

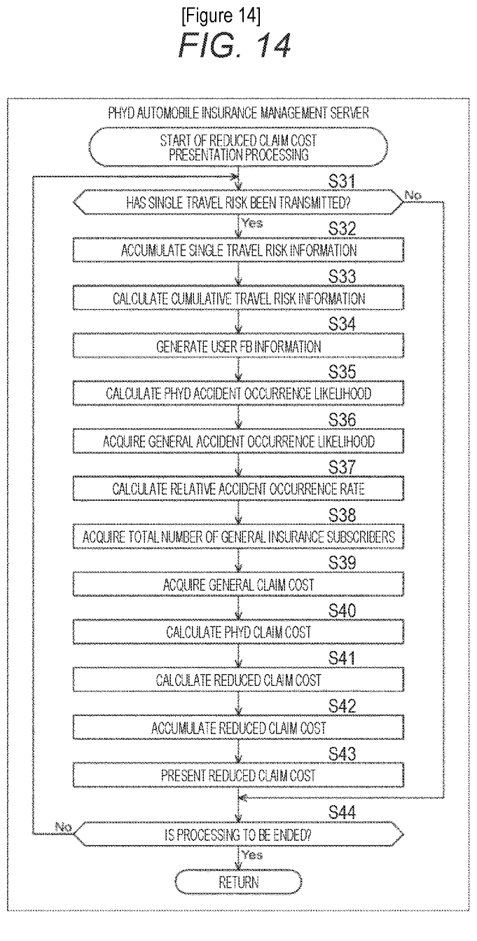

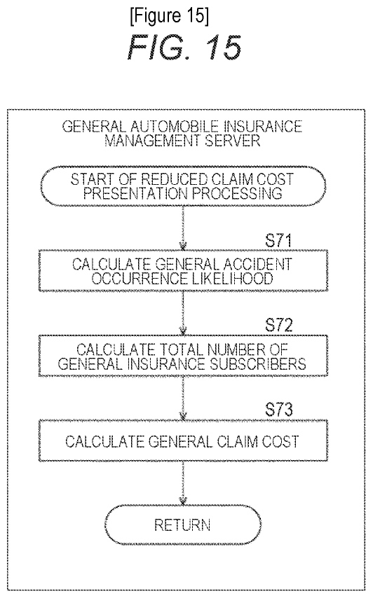

Note that FIG. 13 illustrates processing by the smartphone 152 in the vehicle 131, FIG. 14 illustrates processing by the PHYD automobile insurance management server 132, and FIG. 15 illustrates processing by the general automobile insurance management server 133.

In step S11 (FIG. 13), the single travel risk information calculation unit 231 of the smartphone 152 owned by an insurance subscriber of the PHYD automobile insurance, who is a driver of the vehicle 131, determines whether or not an engine is started on the basis of a detection result including sensor information and measurement meta-information transmitted from the dedicated HW 151, and repeats similar processing until the engine is started.

In a case where it is determined in step S11 that the engine is started, the single travel risk information calculation unit 231 causes the processing to proceed to step S12.

In step S12, the single travel risk information calculation unit 231 acquires a detection result related to an action of the driver on the basis of the sensor information and the measurement meta-information transmitted from the dedicated HW 151.

In step S13, the single travel risk information calculation unit 231 calculates a value or a score indicating a travel risk on the basis of the detection result related to the action of the driver.

In step S14, the single travel risk information calculation unit 231 accumulates the calculated value or score indicating the travel risk.

In step S15, the single travel risk information calculation unit 231 determines whether or not the engine is stopped on the basis of the detection result including the sensor information and the measurement meta-information transmitted from the dedicated HW 151.

In a case where it is determined in step S15 that the engine is not stopped, the processing returns to step S12.

That is, the processes in steps S12 to S15 are repeated to repeat processing for calculating and accumulating the value or score indicating the travel risk until the engine is started and then stopped.

Then, in a case where it is determined in step S15 that the engine is stopped, the processing proceeds to step S16.

In step S16, the single travel risk information calculation unit 231 controls the communication unit 215 to transmit a cumulative travel risk to the PHYD automobile insurance management server 132 via the network 141 as single travel risk information including the travel risk for one-time travel from the start to the stop of the engine.

In step S31 (FIG. 14), the cumulative travel risk information calculation unit 271 controls the communication unit 255 to determine whether or not the single travel risk information has been transmitted from the smartphone 152 possessed by the driver of the vehicle 131 who is the insurance subscriber of the PHYD automobile insurance via the network 141.

In a case where the single travel risk information has been transmitted in step S31, the processing proceeds to step S32.

In step S32, the cumulative travel risk information calculation unit 271 controls the communication unit 255 to accumulate the single travel risk information transmitted from the smartphone 152 via the network 141 in the past travel risk information accumulation unit 281 and the entire PHYD subscriber single travel risk information accumulation unit 282.

In step S33, the cumulative travel risk information calculation unit 271 adds the acquired single travel risk information to past single travel risk information accumulated in the past travel risk information accumulation unit 281 to calculate cumulative travel risk information at the current time, and supplies the cumulative travel risk information to the user FB information generation unit 272.

In step S34, the user FB information generation unit 272 generates user FB information including a cashback amount and driving habit improvement advice on the basis of the cumulative travel risk information and controls the communication unit 255 to transmit the user FB information to the smartphone 152.

Through this processing, the user FB information including the cashback amount and the driving habit improvement advice is generated on the basis of the cumulative travel risk information in which the single travel risk information is cumulatively accumulated, and is transmitted to the smartphone 152 together with the cumulative travel risk information.

Therefore, in step S17 (FIG. 13), the single travel risk information calculation unit 231 controls the communication unit 215 to receive the user FB including the cumulative travel risk information, the cashback amount, and the driving habit improvement advice transmitted from the PHYD automobile insurance management server 132 via the network 141 on the basis of the single travel risk information, and displays the user FB on the output unit 213.

Through the above processing, the driving action of the driver of the vehicle 131 who is the insurance subscriber subscribing to the PHYD automobile insurance is measured, and the single travel risk information including the value or score related to the travel risk is generated on the basis of the measured driving action and transmitted to the PHYD automobile insurance management server 132.

Furthermore, the user FB information including the cumulative travel risk information, the cashback amount, and the driving habit improvement advice transmitted from the PHYD automobile insurance management server 132 is generated on the basis of the transmitted single travel risk information and can be presented to the insurance subscriber.

In step S35 (FIG. 14), the PHYD accident occurrence likelihood calculation unit 273 calculates a PHYD accident occurrence likelihood on the basis of pieces of the single travel risk information of all the subscribers accumulated in the entire PHYD subscriber single travel risk information accumulation unit 282, and outputs the PHYD accident occurrence likelihood to the relative accident occurrence rate calculation unit 274.

Here, in the general automobile insurance management server 133, the general accident occurrence likelihood calculation unit 311 reads general automobile insurance entire subscriber single risk information from the entire general subscriber single travel risk information accumulation unit 321, calculates a general accident occurrence likelihood, and controls the communication unit 295 to transmit the general accident occurrence likelihood to the PHYD automobile insurance management server 132 in step S71 (FIG. 15).

In step S36 (FIG. 14), the relative accident occurrence rate calculation unit 274 controls the communication unit 255 to acquire the general accident occurrence likelihood transmitted from the general automobile insurance management server 133.

In step S37, the relative accident occurrence rate calculation unit 274 calculates a relative accident occurrence rate by, for example, calculating Formula (1) on the basis of the PHYD accident occurrence likelihood and the general accident occurrence likelihood, and outputs the relative accident occurrence rate to the reduced claim cost calculation unit 276.

Here, in the general automobile insurance management server 133, the total general insurance subscriber count calculation unit 312 calculates a total number of insurance subscribers of the general automobile insurance, and controls the communication unit 295 to transmit the total number to the PHYD automobile insurance management server 132 in step S72 (FIG. 15).

Therefore, in step S38 (FIG. 14), the PHYD claim cost calculation unit 275 controls the communication unit 255 to acquire the total number of insurance subscribers of the general automobile insurance transmitted from the general automobile insurance management server 133 via the network 141.

Furthermore, in step S73 (FIG. 15), the general claim cost calculation unit 313 calculates a claim cost of the general automobile insurance, and controls the communication unit 295 to transmit the claim cost to the PHYD automobile insurance management server 132.

Therefore, in step S39 (FIG. 14), the PHYD claim cost calculation unit 275 acquires the claim cost of the general automobile insurance transmitted from the general automobile insurance management server 133 via the network 141.

In step S40, the PHYD claim cost calculation unit 275 calculates Formula (2), for example, to calculate a PHYD claim cost, which is a claim cost of the PHYD automobile insurance at the current time, on the basis of information regarding the total number of subscribers of the PHYD automobile insurance in addition to the information regarding the total number of subscribers of the general automobile insurance supplied from the total general insurance subscriber count calculation unit 312 and the claim cost of the general automobile insurance supplied from the general claim cost calculation unit 313, and outputs the PHYD claim cost to the reduced claim cost calculation unit 276.

In step S41, the reduced claim cost calculation unit 276 calculates Formula (3), for example, to calculate a reduced claim cost at the current time on the basis of the relative accident occurrence rate supplied from the relative accident occurrence rate calculation unit 274 and the PHYD claim cost supplied from the PHYD claim cost calculation unit 275.

In step S42, the reduced claim cost calculation unit 276 causes the reduced claim cost accumulation unit 283 to read information regarding the reduced claim cost accumulated up to an immediately preceding timing, integrate the calculated reduced claim cost, and accumulate the integrated reduced claim cost in the reduced claim cost accumulation unit 283.

In step S43, the reduced claim cost presentation unit 277 reads information regarding the reduced claim cost accumulated in the reduced claim cost accumulation unit 283, generates a moving image presenting the reduced claim cost, for example, as illustrated in FIGS. 8 to 12, and presents the generated image when the presentation of the reduced claim cost is requested by the access of the PC 134, the smartphone 152,135, or the like.

In step S44, the cumulative travel risk information calculation unit 271 determines whether or not an instruction to end the processing has been given, and, in a case where the instruction to end the processing has not been given, the processing returns to step S31 to repeat the subsequent processes.

That is, the processes in steps S31 to S44 are repeated until the instruction to end the processing is given, and the reduced claim cost is calculated every time the single travel risk information is transmitted, and the image presenting the reduced claim cost is generated.

Then, in a case where the instruction to end the processing is given in step S44, the processing ends. Note that the processes in steps S32 to S43 are skipped in a case where the single travel risk information is not transmitted in step S31.

Through the above processing, it is possible to improve the driving habit of the insurance subscriber of the PHYD automobile insurance by presenting the cashback amount based on the driving action of the driver and the advice regarding driving as the single travel risk information of the PHYD automobile insurance subscriber is supplied, it is possible to improve a satisfaction level of the insurance subscriber and to reduce automobile accidents by reducing an insurance premium of a user, and it is possible to improve the profit of an automobile insurance company due to reduction of the claim cost.

Since the reduced claim cost is updated every time the single travel risk information is acquired, the insurance subscriber can quantitatively recognize to some extent how much the reduced claim cost can be improved by the behavior modification of improving the own driving habit by requesting the PHYD automobile insurance management server 132 to present the reduced claim cost.

Therefore, a PHYD automobile insurance policyholder can realize the effect of the behavior modification in addition to the sense of superiority and the sense of achievement with respect to the subscription to the PHYD automobile insurance, and it is possible to further enhance motivation to achieve the behavior modification that suppresses the occurrence of the accident.

Moreover, since the cashback amount according to the behavior modification is presented and the reduced claim cost can be explicitly presented, it is possible to present that cashback according to the behavior modification is actually provided, and to make the transparency of the cash flow of the PHYD automobile insurance known.

Furthermore, it is possible to appeal, as a sales point of the insurance product, the provision of the cashback to reduce the insurance premium along with the behavior modification, and the reduced claim cost increases along with the behavior modification by subscribing to the PHYD automobile insurance and the realization of social contribution of substantially reducing the number of accidents occurring.

### Application Examples

Although the example applied to the PHYD automobile insurance has been described above, the present invention may be applied to other things.

For example, the present invention may be applied to a life insurance or a medical insurance instead of the PHYD automobile insurance.

In a case of being applied to the life insurance or the medical insurance, a biological information acquisition HW, which includes a wearable device such as a smart watch or the like acquiring biological information of an insurance subscriber, may be provided instead of the dedicated HW 151 that detects the driving habit of the insurance subscriber mounted on the vehicle 131.

That is, in the case of being applied to the life insurance or the medical insurance, biological risk information including values or scores calculated by the biological information acquisition HW from heart rate/respiration/blood oxygen concentration/core temperature/exercise amount/dietary prescription, calorie intake/stress level, or the like may be used instead of the travel risk information.

Moreover, in the case of the life insurance or the medical insurance, a disease infection rate/injury occurrence rate may be used instead of the accident occurrence rate, and a claim cost caused by a disease/injury or the like may be used instead of the accident claim cost.

That is, behavior modification in the case of being applied to the life insurance or the medical insurance is behavior for maintaining health more, and it is possible to maintain a health state and reduce burden of an insurance premium of the insurance subscriber by measuring the behavior modification for maintaining the health state and allowing the insurance subscriber who maintains the health state to obtain a benefit such as cashback, and it is possible to make an appeal as an insurance product that can promote health in the entire society.

Moreover, the present invention may be applied to a communication service instead of the PHYD automobile insurance.

In the case of being applied to the communication service, a communication information acquisition HW that detects communication situations of all devices that use a provided communication domain may be provided instead of the dedicated HW 131.

Furthermore, in the case of being applied to the communication service, the communication situations may be detected by all the devices themselves using the provided communication domain.

That is, in the case of being applied to the communication service, communication information such as communication usage amount and communication usage time may be used by the communication information acquisition HW instead of the travel risk information.

Moreover, in the case of being applied to the communication service, a bandwidth occupancy/congestion level may be used instead of the accident occurrence rate, and in addition, a packet fee may be applied instead of the accident claim cost.

That is, behavior modification in the case of being applied to the communication service is behavior that does not adversely affect a communication environment recognized by the usage/usage time, a predicted bandwidth occupancy/congestion level, or the like (behavior that suppresses the predicted bandwidth occupancy/congestion level), and it is possible to reduce burden of communication fees of users who receive the communication service by measuring information indicating an influence on the communication environment and allowing a user who does not adversely affect the communication environment to obtain a benefit such as cashback, and it is possible to make an appeal as a communication service that can improve the communication environment in the entire society.

According to the present disclosure, it is possible to present a result of behavior modification of the entire group in any case, and it is possible to encourage further behavior modification by presenting the result of the behavior modification.

### 3. Example Executed by Software

Meanwhile, the above-described series of processes can be executed by hardware, and can also be executed by software. In a case where the series of processes is executed by software, a program constituting the software is installed from a recording medium to a computer incorporated in dedicated hardware or, for example, a general-purpose computer or the like capable of executing various functions by installing various programs.

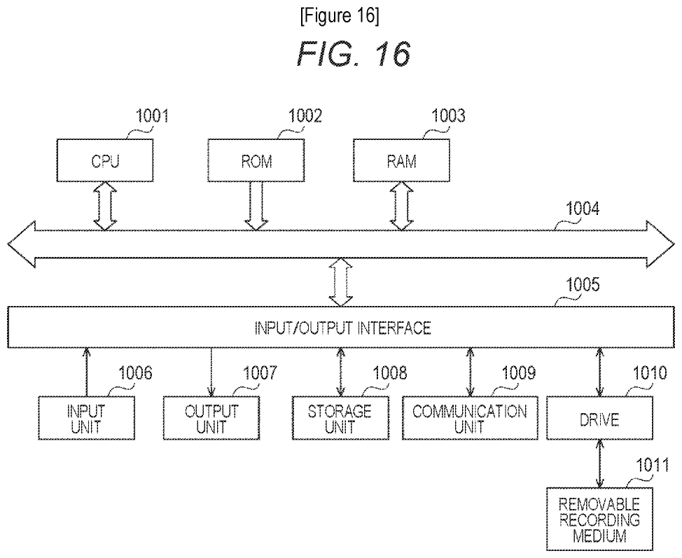

FIG. 16 illustrates a configuration example of the general-purpose computer. This personal computer includes a built-in central processing unit (CPU) 1001. An input/output interface 1005 is connected to the CPU 1001 via a bus 1004. A read only memory (ROM) 1002 and a random access memory (RAM) 1003 are connected to the bus 1004.

The input/output interface 1005 includes: an input unit 1006 configured using an input device such as a keyboard and a mouse through which a user inputs an operation command; an output unit 1007 that outputs a processing operation screen and an image of a processing result to a display device; a storage unit 1008 configured using a hard disk drive or the like that stores a program and various pieces of data; a local area network (LAN) adapter, and the like, and a communication unit 1009 that executes communication processing via a network represented by the Internet is connected thereto. Furthermore, a drive 1010, which reads and writes data from and to the removable storage medium 1011, such as a magnetic disc (including a flexible disc), an optical disc (including a compact disc-read only memory (CD-ROM) and a digital versatile disc (DVD)), a magneto-optical disc (including a mini disc (MD)), or a semiconductor memory, is connected.

The CPU 1001 executes various processes according to a program stored in the ROM 1002 or a program read from the removable storage medium 1011 such as a magnetic disc, an optical disc, a magneto-optical disc, or a semiconductor memory, installed in the storage unit 1008 and loaded from the storage unit 1008 to the RAM 1003. Furthermore, the RAM 1003 also appropriately stores data and the like necessary for the CPU 1001 to execute various processes.

In the computer configured as described above, for example, the CPU 1001 executes a program stored in the storage unit 1008 in the state of being loaded on the RAM 1003 via the input/output interface 1005 and the bus 1004, thereby performing the above-described series of processes.

The program executed by the computer (CPU 1001) can be provided in the state of being recorded on, for example, the removable storage medium 1011 as a package medium or the like. Furthermore, the program can be provided via a wired or wireless transmission medium such as a local area network, the Internet, and digital satellite broadcasting.

In the computer, the program can be installed in the storage unit 1008 via the input/output interface 1005 by mounting the removable storage medium 1011 to the drive 1010. Furthermore, the program can be received by the communication unit 1009 via a wired or wireless transmission medium and installed in the storage unit 1008. In addition, the program can be installed in advance in the ROM 1002 and the storage unit 1008.

Note that the program executed by the computer may be a program in which the processes are performed in a time-series order according to the order described in the present specification or may be a program in which the processes are performed in parallel or at necessary timing such as when a call is made.

Note that the CPU 1001 in FIG. 16 implements the functions of the control unit 211 in FIG. 4, the control unit 251 in FIG. 5, and the control unit 261 in FIG. 6.

Furthermore, the system in the present specification means a set of a plurality of constituent elements (devices, modules (components), and the like), and whether or not all the constituent elements are provided in the same housing does not matter. Therefore, both a plurality of devices housed in separate housings and connected via a network, and a device in which a plurality of modules is housed in one housing are systems.

Note that embodiments of the present disclosure are not limited to the above-described embodiments, and various modifications can be made within a scope not departing from a gist of the present disclosure.

For example, the present disclosure can adopt a cloud computing configuration in which one function is shared and processed by a plurality of devices via a network.

Furthermore, each step described in the above-described flowcharts can be not only executed by one device but also shared and executed by a plurality of devices.

Moreover, in a case where a plurality of processes is included in one step, the plurality of processes included in one step can be not only executed by one device but also shared and executed by a plurality of devices.

Note that the present disclosure can also have the following configurations.

### <1> An Information Processing Device Including

a risk acquisition unit that acquires information indicating a degree of a risk occurring depending on an action of a user for a service as risk information, the information being related to the service provided in accordance with the action of the user obtained from a sensor; and

a reduced cost calculation unit that calculates a cost to be reduced from a cost related to the provision of the service as a reduced cost on the basis of the risk information.

<2> The Information Processing Device According to <1>, Further Including

a service risk occurrence likelihood calculation unit that calculates a likelihood of occurrence of the risk as a service risk occurrence likelihood on the basis of the risk information,

in which the reduced cost calculation unit calculates the reduced cost on the basis of the service risk occurrence likelihood.

<3> The Information Processing Device According to <2>, in which

the service risk occurrence likelihood calculation unit calculates the likelihood of occurrence of the risk as the service risk occurrence likelihood by regression calculation on the basis of the risk information.

<4> The Information Processing Device According to <3>, in which

a model used for the regression calculation is a Poisson distribution, and a link function is an exponential function having a natural logarithm as a base.

<5> The Information Processing Device According to <2>, Further Including

a service risk occurrence rate calculation unit that calculates an occurrence rate at which the risk occurs as a service risk occurrence rate on the basis of the service risk occurrence likelihood,

in which the reduced cost calculation unit calculates the reduced cost on the basis of the service risk occurrence rate.

<6> The Information Processing Device According to <5>, Further Including

a predetermined risk occurrence likelihood calculation unit that calculates a likelihood of occurrence of a risk occurring at a predetermined proportion for the service as a predetermined risk occurrence likelihood,

in which the service risk occurrence rate calculation unit calculates, as the service risk occurrence rate, a relative occurrence rate at which the risk occurring depending on the action of the user occurs with respect to the risk that occurs at the predetermined proportion, on the basis of the service risk occurrence likelihood and the predetermined risk occurrence likelihood.

<7> The Information Processing Device According to <6>, Further Including

a service provision cost calculation unit that calculates a total cost related to the provision of the service as a service provision cost on the basis of a total number of the users who receives the provision of the service,

in which the reduced cost calculation unit calculates the reduced cost on the basis of the service provision cost and the service risk occurrence rate.

<8> The Information Processing Device According to <7>, in which

the reduced cost calculation unit calculates the reduced cost by multiplying the service provision cost by the service risk occurrence rate.

<9> The Information Processing Device According to <7>, in which

the service provision cost calculation unit calculates the total cost related to the provision of the service on the basis of a cost of the service provided on an assumption that the risk occurs at the predetermined proportion and a total number of users who receive the provision of the service based on the assumption that the risk occurs at the predetermined proportion, in addition to the total number of the users who receive the provision of the service.

<10> The Information Processing Device According to <9>, in which

the service provision cost calculation unit calculates the total cost related to the provision of the service by multiplying the cost of the service provided on the assumption that the risk occurs at the predetermined proportion by a proportion of the total number of the users who receive the provision of the service with respect to the total number of the users who receive the provision of the service based on the assumption that the risk occurs at the predetermined proportion.

<11> The Information Processing Device According to <10>, in which

the service provided in accordance with the action of the user is a pay how you drive (PHYD) automobile insurance service, a life insurance/health insurance service, or a communication service.

<12> The Information Processing Device According to <11>, in which

in a case where the service provided in accordance with the action of the user is the PHYD automobile insurance service,

the action of the user is a driving habit of an insurance subscriber who subscribes to the PHYD automobile insurance service, and

the service risk occurrence rate is a relative accident occurrence rate of the insurance subscriber who subscribes to the PHYD automobile insurance service with respect to a person who does not subscribe to the PHYD automobile insurance service.

<13> The Information Processing Device According to <11>, in which

in a case where the service provided in accordance with the action of the user is the life insurance/health insurance service,

the action of the user is behavior for maintaining a health state of an insurance subscriber who subscribes to the life insurance/health insurance service, and

the service risk occurrence rate is a relative disease infection rate/injury occurrence rate of the insurance subscriber who subscribes to the life insurance/health insurance service with respect to a person who does not subscribe to the life insurance/health insurance service.

<14> The Information Processing Device According to <11>, in which

in a case where the service provided in accordance with the action of the user is the communication service,

the action of the user is behavior that does not affect the communication service, and

the service risk occurrence rate is a relative bandwidth occupancy/congestion degree of a person who subscribes to the communication service with respect to a person who does not subscribe to the communication service.

<15> The Information Processing Device According to any One of <1> to <14>, Further Including:

a reduced cost accumulation unit that accumulates the reduced cost; and

a presentation unit that generates and presents an image indicating a cumulative degree of the reduced cost on the basis of the reduced cost accumulated in the reduced cost accumulation unit.

<16> An Information Processing Method Including:

a step of acquiring information indicating a degree of a risk occurring depending on an action of a user for a service as risk information, the information being related to the service provided in accordance with the action of the user obtained from a sensor; and

a step of calculating a cost to be reduced from a cost related to the provision of the service as a reduced cost on the basis of the risk information.

<17>A Program Causing a Computer to Function as:

a risk acquisition unit that acquires information indicating a degree of a risk occurring depending on an action of a user for a service as risk information, the information being related to the service provided in accordance with the action of the user obtained from the sensor; and

a reduced cost calculation unit that calculates a cost to be reduced from a cost related to the provision of the service as a reduced cost on the basis of the risk information.

<18> An Information Processing System Including:

a risk acquisition unit that acquires information indicating a degree of a risk occurring depending on an action of a user for a service as risk information, the information being related to the service provided in accordance with the action of the user obtained from a sensor; and

a reduced cost calculation unit that calculates a cost to be reduced from a cost related to the provision of the service as a reduced cost on the basis of the risk information.

### REFERENCE SIGNS LIST

111 PHYD automobile insurance management system
131, 131-1 to 131-n Vehicle
132 PHYD automobile insurance management server
133 General automobile insurance management server
134 PC
135 Smartphone
141 Network
151, 151-1 to 151-n Dedicated HW
152, 152-1 to 152-n Smartphone
231 Single travel risk information calculation unit
271 Cumulative travel risk information calculation unit
272 User FB information generation unit
273 PHYD accident occurrence likelihood calculation unit
274 Relative accident occurrence likelihood calculation unit
275 PHYD claim cost calculation unit
276 Reduced claim cost calculation unit
277 Reduced claim cost presentation unit
281 Past travel risk information accumulation unit
282 Entire PHYD subscriber single travel risk
information accumulation unit
283 Reduced claim cost accumulation unit
311 General accident occurrence likelihood calculation unit
312 Total general automobile insurance subscriber count calculation unit
313 General claim cost calculation unit
321 General subscriber single travel risk information accumulation unit

1. An information processing device comprising:
a risk acquisition unit that acquires information indicating a degree of a risk occurring depending on an action of a user for a service as risk information, the information being related to the service provided in accordance with the action of the user obtained from a sensor; and
a reduced cost calculation unit that calculates a cost to be reduced from a cost related to the provision of the service as a reduced cost on a basis of the risk information.

2. The information processing device according to claim 1, further comprising
a service risk occurrence likelihood calculation unit that calculates a likelihood of occurrence of the risk as a service risk occurrence likelihood on a basis of the risk information,
wherein the reduced cost calculation unit calculates the reduced cost on a basis of the service risk occurrence likelihood.

3. The information processing device according to claim 2, wherein
the service risk occurrence likelihood calculation unit calculates the likelihood of occurrence of the risk as the service risk occurrence likelihood by regression calculation on a basis of the risk information.

4. The information processing device according to claim 3, wherein
a model used for the regression calculation is a Poisson distribution, and a link function is an exponential function having a natural logarithm as a base.

5. The information processing device according to claim 2, further comprising
a service risk occurrence rate calculation unit that calculates an occurrence rate at which the risk occurs as a service risk occurrence rate on a basis of the service risk occurrence likelihood,
wherein the reduced cost calculation unit calculates the reduced cost on a basis of the service risk occurrence rate.

6. The information processing device according to claim 5, further comprising
a predetermined risk occurrence likelihood calculation unit that calculates a likelihood of occurrence of a risk occurring at a predetermined proportion for the service as a predetermined risk occurrence likelihood,
wherein the service risk occurrence rate calculation unit calculates, as the service risk occurrence rate, a relative occurrence rate at which the risk occurring depending on the action of the user occurs with respect to the risk that occurs at the predetermined proportion, on a basis of the service risk occurrence likelihood and the predetermined risk occurrence likelihood.

7. The information processing device according to claim 6, further comprising
a service provision cost calculation unit that calculates a total cost related to the provision of the service as a service provision cost on a basis of a total number of the users who receives the provision of the service,
wherein the reduced cost calculation unit calculates the reduced cost on a basis of the service provision cost and the service risk occurrence rate.

8. The information processing device according to claim 7, wherein
the reduced cost calculation unit calculates the reduced cost by multiplying the service provision cost by the service risk occurrence rate.

9. The information processing device according to claim 7, wherein
the service provision cost calculation unit calculates the total cost related to the provision of the service on a basis of a cost of the service provided on an assumption that the risk occurs at the predetermined proportion and a total number of users who receive the provision of the service based on the assumption that the risk occurs at the predetermined proportion, in addition to the total number of the users who receive the provision of the service.

10. The information processing device according to claim 9, wherein
the service provision cost calculation unit calculates the total cost related to the provision of the service by multiplying the cost of the service provided on the assumption that the risk occurs at the predetermined proportion by a proportion of the total number of the users who receive the provision of the service with respect to the total number of the users who receive the provision of the service based on the assumption that the risk occurs at the predetermined proportion.

11. The information processing device according to claim 10, wherein
the service provided in accordance with the action of the user is a pay how you drive (PHYD) automobile insurance service, a life insurance/health insurance service, or a communication service.

12. The information processing device according to claim 11, wherein
in a case where the service provided in accordance with the action of the user is the PHYD automobile insurance service,
the action of the user is a driving habit of an insurance subscriber who subscribes to the PHYD automobile insurance service, and
the service risk occurrence rate is a relative accident occurrence rate of the insurance subscriber who subscribes to the PHYD automobile insurance service with respect to a person who does not subscribe to the PHYD automobile insurance service.

13. The information processing device according to claim 11, wherein
in a case where the service provided in accordance with the action of the user is the life insurance/health insurance service,
the action of the user is behavior for maintaining a health state of an insurance subscriber who subscribes to the life insurance/health insurance service, and
the service risk occurrence rate is a relative disease infection rate/injury occurrence rate of the insurance subscriber who subscribes to the life insurance/health insurance service with respect to a person who does not subscribe to the life insurance/health insurance service.

14. The information processing device according to claim 11, wherein
in a case where the service provided in accordance with the action of the user is the communication service,
the action of the user is behavior that does not affect the communication service, and
the service risk occurrence rate is a relative bandwidth occupancy/congestion level of a person who subscribes to the communication service with respect to a person who does not subscribe to the communication service.

15. The information processing device according to claim 1, further comprising
a reduced cost accumulation unit that accumulates the reduced cost; and
a presentation unit that generates and presents an image indicating a cumulative degree of the reduced cost on a basis of the reduced cost accumulated in the reduced cost accumulation unit.

16. An information processing method comprising:
a step of acquiring information indicating a degree of a risk occurring depending on an action of a user for a service as risk information, the information being related to the service provided in accordance with the action of the user obtained from a sensor; and
a step of calculating a cost to be reduced from a cost related to the provision of the service as a reduced cost on a basis of the risk information.

17. A program causing a computer to function as:
a risk acquisition unit that acquires information indicating a degree of a risk occurring depending on an action of a user for a service as risk information, the information being related to the service provided in accordance with the action of the user obtained from a sensor; and
a reduced cost calculation unit that calculates a cost to be reduced from a cost related to the provision of the service as a reduced cost on a basis of the risk information.

18. An information processing system comprising:
a risk acquisition unit that acquires information indicating a degree of a risk occurring depending on an action of a user for a service as risk information, the information being related to the service provided in accordance with the action of the user obtained from a sensor; and
a reduced cost calculation unit that calculates a cost to be reduced from a cost related to the provision of the service as a reduced cost on a basis of the risk information.
